(19) United States
(12) Patent Application Publication
(10) Pub. No.: US 2002/0065702 A1
(43) Pub. Date: May 30, 2002

(54) Real-time production tracking and scheduling system

(76) Inventor: David L. Caulfield, Orange, CA (US)

Correspondence Address: Harry G. Weissenberger, Esq., 4 Venture, Suite 300, Irvine, CA, 92618-7384, US

(21) Appl. No.: 09/726,063

(22) Filed: Nov. 29, 2000

Related U.S. Application Data
(60) Provisional application No. 60/228,162, filed on Aug. 25, 2000.

(51) Int. Cl. G06F 17/60

(52) U.S. Cl. 705/9; 705/11

(57) ABSTRACT

A computerized method of enabling the management of an automotive repair shop to optimize production by computing a job completion target through optimally scheduling a sequence of tasks on the basis of the availability and historical efficiency of individual technicians and historical average idle time of technicians and vehicles during the performance of the job, and providing detailed performance data of individual technicians on individual jobs for problem evaluation if the computed optimized target is not met.

### RELATED CASES

This is a nonprovisional filing corresponding to Provisional Application Serial No. 60/228162 filed Aug. 25, 2000.

### FIELD OF THE INVENTION

This invention relates to a computerized system for scheduling and tracking labor-intensive jobs involving sequential tasks by a plurality of employees, and more particularly to a system providing a calculated prediction of the completion time of the job, assigning appropriate personnel, tracking the progress of the job, and providing management information.

### BACKGROUND OF THE INVENTION

Labor-intensive services that are typically purchased on the basis of binding bids are generally subject to intense competition, so that the quality and speed of service, as well as the optimum utilization of skilled labor, are critical factors in the success of the service business.

For example, automotive collision repair is conventionally sold on the basis of estimates or bids, with the job being awarded to the lowest bidder. Although experienced estimators can usually predict the cost and time required to do a job fairly accurately, repair jobs involve human productivity and scheduling factors that, in the present state of the art, result in labor utilization rates that cannot easily be anticipated by the estimator. Consequently, even experienced estimators can easily bid too low to make a profit, or too high to get the job.

In addition, insurers and customers are often highly time-conscious, and may well award a job to the fastest repair shop even though that shop may not be the low bidder. It is therefore important for estimators to know, upon submitting a bid, when the shop will be ready to start work on a car and when the job can be expected to be completed. Neither of these times can presently be predicted anywhere near accurately, because in the present state of the art, availability of technicians and the actual time elapsed between the start and the end of the job cannot accurately be predicted.

From a customer service point of view, it is also important to keep customers and insurers periodically informed of the progress of the job so the customer or insurer can evaluate whether the job completion prediction is likely to be met.

From a management point of view, effective management of the collision repair shop or other similar labor-intensive facility is directed, in large measure, toward identifying and resolving production bottlenecks and underutilization of expensive production personnel, and toward determining the amount of business the shop can accept. In the collision repair industry in particular, this has in the past been very difficult to do. Collision repair work inherently involves a series of tasks (e.g. body work, painting, color sanding/buffing etc.) that must at least partially be performed in sequence by several of technicians with different skills.

Some technicians work faster than others; some keep different hours than others; some tend to be careless and need to rework a botched task; and many work alternatively on two or more cars in their department. It thus happens that both the cars and the technicians at times experience idle time due to poor scheduling of technicians, technical or parts problems, or car movements between departments.

In the past, experienced estimators would make an educated guess as to the overall length of time needed to repair a car, and would promise completion of the work accordingly. When the guess turned out to be substantially wrong, there was no way to determine what labor or scheduling problems had resulted in the delay. If this occurred repeatedly, management was in a quandary as to where in the operation remedial action needed to be taken.

### SUMMARY OF THE INVENTION

The present invention allows shop management to optimize the utilization of the shop's technicians and facilities, and thereby to repair more cars in a shorter time with existing personnel, by automatically a) continually determining the historical work efficiency of individual technicians in real time; b) assigning work to technicians in accordance with their availability; c) scheduling the technicians' work in accordance with their efficiency; d) determining the average unavoidable idle time both of the cars and of individual technicians for a given type of repair; e) setting a performance goal or schedule target based on the above factors; and f) providing reports on the degree of achievement of the target and the detailed circumstances contributing to any delays. In addition, the invention allows accurate scheduling of the start of a job as well as its completion so as to minimize the time spent by a car in the shop and meet promised delivery deadlines. This is made possible by tracking each event in the repair of a car through data entries by each technician on a computer workstation at their work location.

### BRIEF DESCRIPTION OF THE DRAWINGS

FIG. 1 is an overall block diagram of the system of this invention;

FIG. 2 is a flow chart illustrating the operation of the scheduling function;

FIG. 3 is a flow chart illustrating the operation of the event processing function;

FIG. 4 is a flow chart illustrating the operation of the efficiency/utilization function; and

FIG. 5 is a block diagram of the reporting function.

### DESCRIPTION OF THE PREFERRED EMBODIMENT

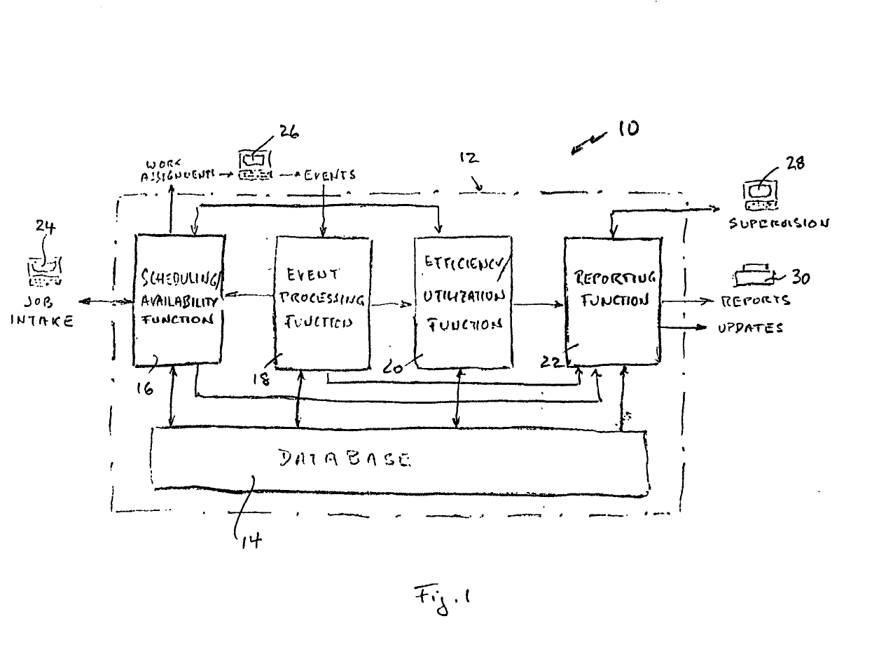

FIG. 1 illustrates the overall organization of the system 10 of this invention. The heart of the system 10 is a central computer 12 which includes a database 14 and four major data processing functions 16, 18, 20 and 22. Data is supplied to the system 10 by job intake workstations 24 and technician workstations 26. The operation of the repair facility associated with the system 10 is monitored by supervisory workstations 28 which can direct the system 10 to generate desired reports at a designated workstation or on the printer 30.

The data processing function 16, which is described in more detail below, is a scheduling and personnel availability function. Estimators at a job intake workstation 24 provide data to the scheduling function 16 regarding the estimated type and amount of work to be done on a car to be repaired. Based on that data, the technician efficiency and availability data stored in the database 14, and the historical average idle time of cars and technicians during the repair process, the scheduling function 16 selects technicians and computes an optimum time required by them for the performance of all tasks involved in the job. That time, when added to the calculated job start time, can be recorded in the database 14 as the repair target or goal, i.e. the expected time of delivery of the repaired car, and may be so reported to the customer.

In accordance with the schedule thus computed, the system 10 assigns work on a particular car or repair order to specific technicians in each department. Theoretically, if all the data in the database 14 is correct, and nothing unexpected happens during the repair job, the scheduled completion target should be met more or less exactly. If it is not, the below-described functions of the system 10 will enable management to identify any problems and take remedial action where appropriate. The event processing function 18 receives its input from the technicians' workstations 26 as each technician enters on his workstation 26 the beginning, interruption, restart or end of a repair task he is performing on a specific car. All events are recorded in the database 14 and are available to the other functions for scheduling, computation and reporting purposes.

The efficiency/utilization function 20 compares the scheduled execution of tasks to their actual execution as determined by the event processing function, and computes from that data and from historical data stored in the database 14 the efficiency of individual technicians and technician/helper teams. This function also keeps track of the utilization rate of the business' resources, i.e. the idle time of technicians and the idle time of cars between repair tasks.

The reporting function 22 receives data from each of the other functions and from the database 14, and generates desired reports and status updates automatically or as requested by the supervisory workstation 28.

The operation of the system 10 can best be described in terms of functional modules as follows:

1. Scheduling

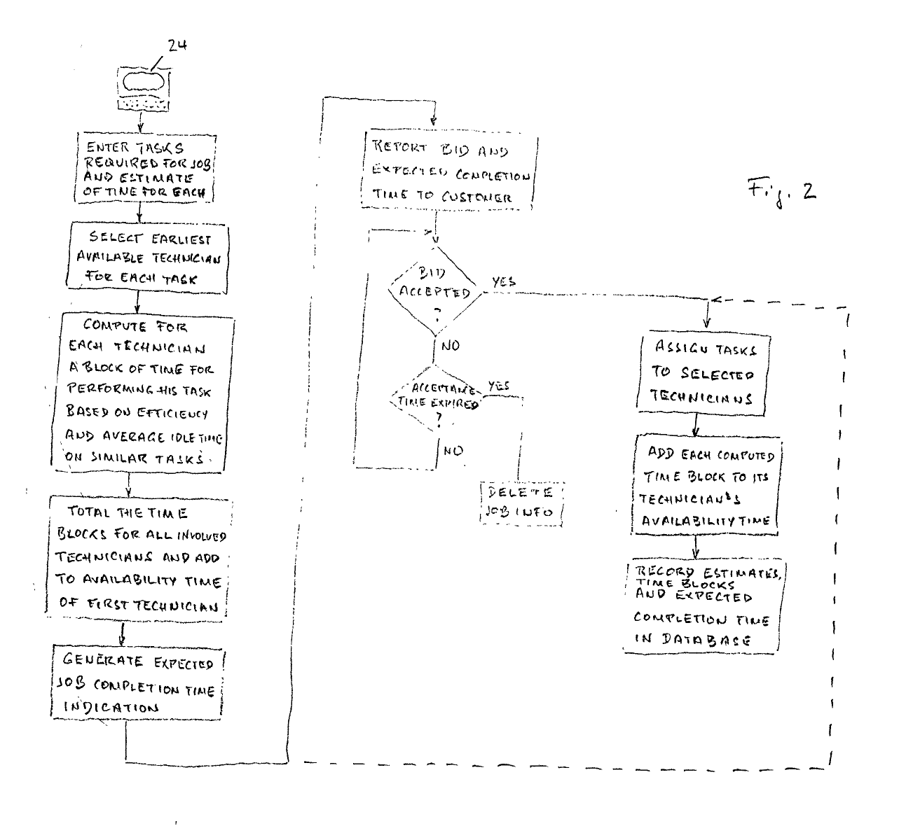

As illustrated in the flow chart of FIG. 2, a bid may be entered at the job intake workstation 24 by an estimator, for example at 2:30 p.m. on Tuesday, October 3. The bid, i.a., identifies the vehicle and estimates the repair work required, e.g. 1.6 hours of body work, 2.7 hours of paint work, and 2.0 hours of color sand/buff work.

The scheduling function 16 now searches the database 14 for the first available body shop technician. This may, for example, be technician B2 whose currently assigned tasks are predicted by the availability data to keep him busy until 11:12 a.m. on Friday, October 6. The customer may thus be instructed, if the bid is accepted, not to bring the car in until Friday morning. The ability of the system 10 to accurately predict the date and time at which a technician will be able to start work on a car is important. Keeping a car idle in the shop's lot for days while awaiting the start of repair work not only wastes space, but subjects the customer or his insurer to unnecessary 20 rental car costs if the car is still drivable.

The scheduling function 16 now determines from the database 14 that technician B2 historically completes assignments, on the average, in three-fourths of the estimated time. Consequently, the function 16 determines that the body work will require 1.4 hours, allowing 0.2 hours for bringing the car into the work bay. It also determines from the data stored in database 14 how much idle time technician B2 can be expected to have between the start and the end of his task. This is done by selecting similar tasks from the database 14, e.g. tasks performed by technician B2 that were estimated at ±5% of the labor estimate of the present task. The historical average of the idle times experienced during those previous tasks is calculated and is added to the projected working time of 1.4 hours. Assuming the historical idle time to be, for example, 0.8 hours, the scheduling function computes that the body work on the car will require a 2.2 hour block of technician B2's time.

The scheduling function now looks for the first available paint technician. This may be technician P3. Having determined from the database 14 that technician P3 historically takes 1.2 times the estimated time to do a task, and that he historically has 1.1 hours of idle time on this type of job, the function 16 computes that the painting task will require about a 3.3 hour block of technician B3's time.

In the same manner, the scheduling function 16 computes a time block of 2.5 hours for color sanding/buffing technician C1 (assuming that technician C1 historically completes work in 0.8 times the estimated time and historically has 0.9 hours of idle time during this type of task).

The time blocks computed for technicians B2, P3 and C1 are now added together, for a total of 8.0 labor hours. This time is added to the projected starting time of 11:12 a.m. Friday. Keeping in mind an 8 a.m. to 5 p.m. workday, 1-hour lunch breaks, twice-daily 0.3 hour coffee breaks, and non-working weekends, it will be seen that the scheduling function 16 will project completion of the repair job at 11:48 a.m. on Monday, October 9. This information can now be communicated to the potential customer together with the dollar amount of the bid.

If the customer accepts the bid or immediately (dotted line in FIG. 2) if the job is not subject to bid, a repair order is issued, and the computed time blocks, estimates, and projected completion date are entered into the database 14. At the same time, the individual time blocks computed for technicians B2, P3 and C1 are added to any time blocks previously assigned to them in database 14 by the scheduling/availability function 16 to pinpoint their availability time for the next bid.

It will be understood that provision may advantageously be made for the manual or automatic selection of a particular technician when, for example, an unusual type of damage requires a technician with special skills.

2. Event Processing

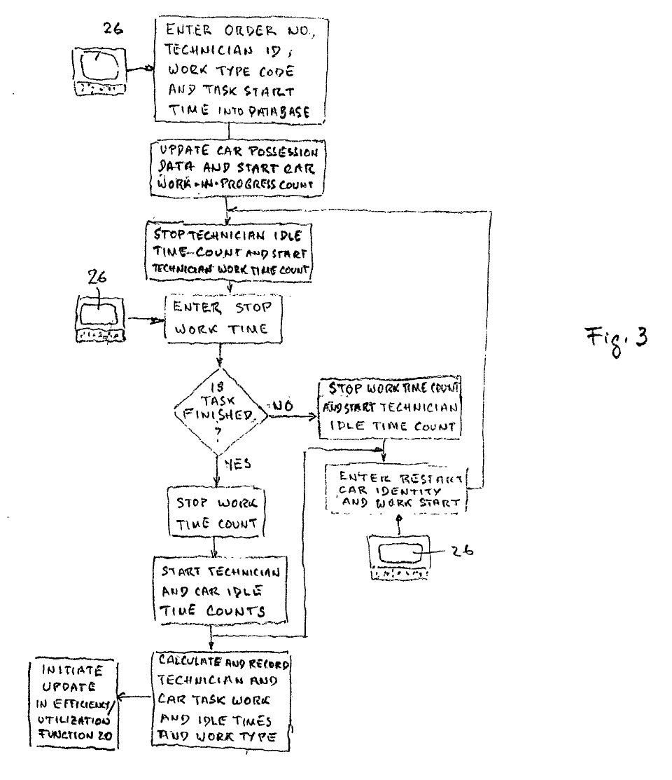

As illustrated in the flow chart of FIG. 3, each event in a technician's work flow, such as starting a task, completing a task, interrupting a task (e.g. to work on another car), seeking special authorizations, etc. is entered by the technician on his workstation 26. For example, when technician B2 finishes his previous task, he records that event and consults his workstation 26 for his next assignment recorded in database 14 by the scheduling function 16.

He then gets the current car and enters a start-work event on the repair order associated with that car. If, during his work, a question arises e.g. as to whether a certain item of work is authorized, he can query a supervisor on the workstation 26. Until the supervisor replies, the function 18 records idle time, which does not count against work efficiency. Likewise, time spent getting a part is entered on the workstation 26 and is recorded as idle time. If work on a car is temporarily discontinued e.g. due to the unavailability of a critical part or other reason, an end work/incomplete entry is made, and the function 18 holds the task in suspension while the technician does other work. If a part order will delay the repair job significantly, a note entered by the technician will alert the estimator to call the customer and advise him of the expected delay. Within allowed time limits, lunch and other authorized breaks are not recorded as idle time, as they are built into the technician's available on-duty time data used by the scheduling function 16.

3. Efficiency and Utilization

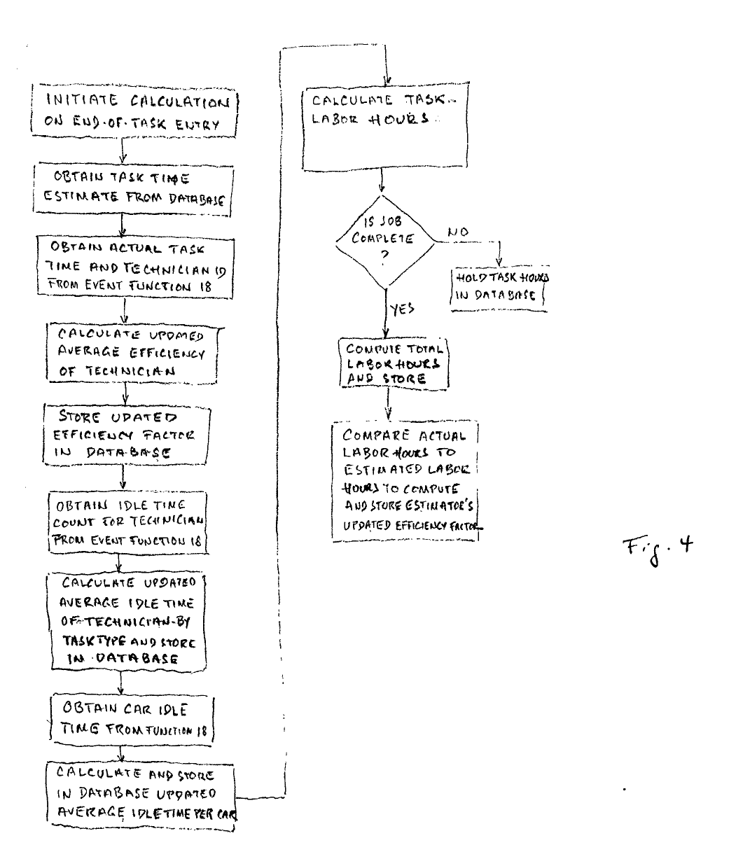

FIG. 4 illustrates the computation of efficiency and utilization data for individual technicians and teams. Each time an event is entered, the function 20 updates the records of the technician making the entry. For example, a start-task entry updates a car possession register to keep track of which technician has the car; an interrupt entry starts a technician and car idle time counter; and a task-completed entry triggers a comparison of the actual time expended on the task with the estimated time, and a resulting update of the technician's historic efficiency factor (which, as described above, is used by the scheduling function 16 in scheduling the technician's work). A task-completed entry also begins an idle-time count for both the technician and the car until the start of the next task for each. The idle-time counts provide valuable statistical information for the shop management, and as described above, are used by the scheduling function 16.

Typically, each task or job is inspected by a supervisor upon completion. If anything is unsatisfactory, the responsible technician will be asked to correct the deficiency and to enter the correcting task as rework. The time consumed by such rework is logged against the technician's efficiency factor. Entry of the last task completion for a given car provides data regarding the total labor hours, by technician, used on the car. This is compared by the function 20 to the estimated hours and is used to generate an historic efficiency rating for the estimator that allows fine-tuning of the estimates or bids.

4. Reports

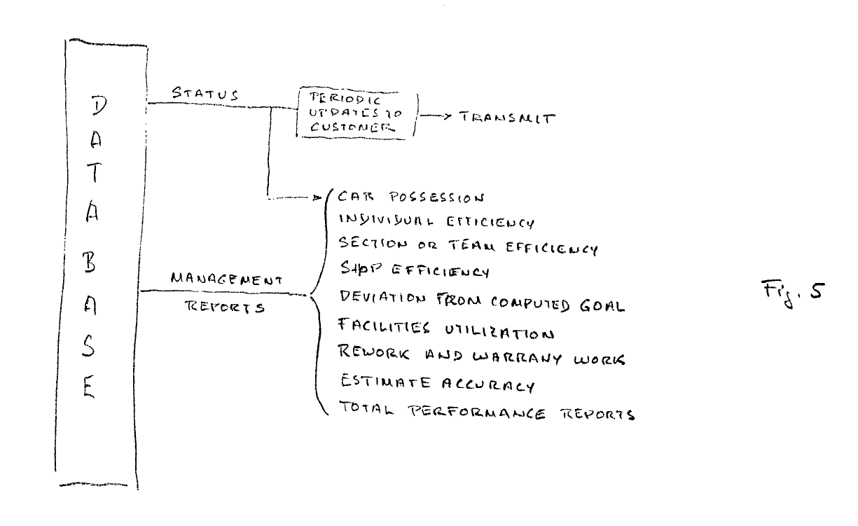

It will be appreciated that the above-described data stored in the database 14 enables the reporting function 22 to generate a wide variety of reports (for example those shown in FIG. 5) to management personnel. Also, interested parties such as customers and insurers can be advised at any time of the current status of the repair of any given car; or they can be automatically so advised at selectable predetermined intervals through status updates generated for transmission by fax or e-mail.

From a management point of view, reports of the efficiency factors recorded for individual technicians and estimators are useful in assessing promotions or salary incentives, or in remedying problems in specific departments. Reports of cars' and technicians' idle time allow assessment of personnel needs.

The main utility of the data available to management through the present invention is, however, the ability to closely monitor the performance of repair orders and thereby to identify repetitive types of deviations from the optimized calculated target that can be improved by reorganizations or other management policies. It will be noted that, as good management reduces the average idle times of cars and technicians, the scheduling function will inherently set ever tighter targets until the shop is performing as optimally as possible.

It is understood that the exemplary real-time computerized production tracking and scheduling system described herein and shown in the drawings represents only a presently preferred embodiment of the invention. Indeed, various modifications and additions may be made to such embodiment without departing from the spirit and scope of the invention. Thus, other modifications and additions may be obvious to those skilled in the art and may be implemented to adapt the present invention for use in a variety of different applications.

I/we claim:

1. A method of determining the expected time required for the performance of a task by an employee, comprising the steps of:
a) entering into a computer memory an initial estimate of the time normally required for the performance of said task;
b) entering into said memory data representing the actual time used by said employee in performing tasks;
c) maintaining in said memory for said employee a cumulative historical efficiency factor representing the ratio of the sum of times previously actually used by said employee for the performance of tasks to the sum of the times previously estimated for the performance of those tasks;
d) multiplying said initial estimate by said efficiency factor; and
e) generating from said multiplication an adjusted estimate of the time required for the performance of said task by said employee.

2. The method of claim 1, further comprising the steps of:
f) using said adjusted estimates for a plurality of employees to compute a target time for the completion of a job involving the sequential performance of a plurality of tasks.

3. A method of predictively scheduling a job performed for a customer involving the performance of a plurality of tasks by a plurality of employees each performing one of said tasks, comprising the steps of:
a) entering into a computer memory an estimate of the time required to perform each of said tasks;
b) maintaining in said memory information for each employee regarding the availability time at which that employee is next expected to be available to perform a given one of said tasks;
c) entering into said memory the beginning and end time of each task or portion thereof performed by each of said employees;
d) maintaining in said memory, for each employee, an efficiency factor representing the ratio of the time historically actually used by said employee to perform tasks to the time estimated for the performance of those tasks;
e) selecting from said memory for a first of said tasks a first employee next expected to be available to perform said first task;
f) multiplying said estimate of the time required to perform said first task by said efficiency factor of the selected employee to generate an expected actual time for performing said first task;
g) adding said expected actual time to the availability time of the selected employee to generate a new availability time of the selected employee for subsequent jobs;
h) repeating said selecting, multiplying and adding steps for each additional task;
i) generating from said repeating step the total expected actual time for the performance of said job;
j) adding said total expected actual time to the availability time of said first employee; and
k) generating from said last-named adding step an expected completion time of said job.

4. The method of claim 3, further comprising the steps of:
l) maintaining in said memory, for each employee, data representing the idle time of said employee accrued during the performance of his task;
m) computing, for each employee, the historically average idle time accrued during the performance of comparable tasks; and
n) adding the total average idle time for all selected employees to said total expected actual time when generating said expected completion time of said job.

5. The method of claim 3, further including the step of periodically generating a notification to said customer of the task currently being performed on said job.

6. In a vehicular repair shop, a method of monitoring the performance of the repair of a vehicle by technicians, comprising the steps of:
a) entering into a computer memory, for each task involved in the repair of said vehicle, information representative of
i) the identity of the vehicle,
ii) the identity of the technician, the start time of the task and the end time of each portion of the task, and
iii) an estimate of the time normally believed to be required to perform the task;
b) computing, from said entered information, the efficiency of said technician as the ratio of the actual time taken by the technician to perform the task to the time estimated for the performance of the task.

7. The method of claim 6, further comprising the step of
c) generating a report of said computed efficiency.

8. The method of claim 6, further comprising the step of
c) periodically generating a report of the identity of the technician having possession of said vehicle at any given time, and the task being performed thereon.

9. The method of claim 6, further comprising the step of c) computing, from said entered information, the idle time of said technician.

10. The method of claim 6, further comprising the step of
c) computing, from said entered information, the idle time of said vehicle being performed thereon.

11. The method of claim 6, further comprising the step of
c) separately recording in said memory the beginning and end time of a rework of a previously performed task; and
d) adding, in said computing step, the rework time to said actual time taken by said technician to perform said task.

12. A computerized method of operating an automotive repair shop, comprising the steps of:
a) estimating the labor hours required to perform a sequence of tasks necessary for a given repair job;
b) maintaining a computer database containing, for each task-performing employee, efficiency data representing a historical average of the ratio of the hours actually spent on a task by the employee to the hours estimated for that task;
c) generating from said database a revised estimate of said hours for said task; and
d) updating said efficiency data in said database when said employee has performed said task.

13. The method of claim 12, wherein said updating is automatically done by said employee's entering the start and end times of his performance of said task or portions thereof in said database.

14. The method of claim 12, further comprising the step of:
e) maintaining in said database availability data representing, for each employee, the expected time of completion of all the tasks for whose performance said employee has been scheduled.

15. The method of claim 14, further comprising the step of:
f) computing a schedule for said sequence of tasks in accordance with said revised estimate and said availability data.

16. The method of claim 15, further comprising the step of:
g) generating an indication of the target time for completion of said repair job in accordance with said computed schedule.

17. The method of claim 12, further comprising the step of:
e) maintaining in said database idle time data representing a historical average of the time that a vehicle undergoing said repair job is in said shop but is not being worked on.

18. The method of claim 17, further comprising the step of:
f) computing a schedule for the completion of said sequence of tasks in accordance with said revised estimate and said vehicle idle time data.

19. The method of claim 12, further comprising the step of:
e) maintaining in said database for each employee idle time data representing a historical average of the idle time experienced by said employee during the performance of a comparable task.

20. The method of claim 19, further comprising the step of:
f) computing a schedule for the completion of said sequence of tasks in accordance with said revised estimate and said employee idle time data.

21. A computerized method of predicting the time of completion of a job involving the performance of sequential tasks by a plurality of employees, comprising the steps of:
a) maintaining in a database data representing the availability time at which each employee is expected to next be available;
b) selecting an employee for each of said sequential tasks; computing, for each employee, a block of time expected to be needed for the performance of his task;
d) adding said blocks of time to the availability time of the employee selected to perform the first of said tasks; and
e) generating from said adding step an indication of the expected completion time of said job.

22. The method of claim 21, further comprising the step of:
f) adding, for each employee, his computed block of time to his current availability time to determine his availability time for the next job.
